(19) United States
(12) Patent Application Publication
(10) Pub. No.: US 2014/0108802 A1
(43) Pub. Date: Apr. 17, 2014

(54) CONTENT PUBLICATION CONTROL SYSTEM

(71) Applicants: Laurent Clevy, Nozay (FR); Antony Martin, Nozay (FR)

(72) Inventors: Laurent Clevy, Nozay (FR); Antony Martin, Nozay (FR)

(73) Assignee: ALCATEL LUCENT, Paris (FR)

(21) Appl. No.: 14/116,215

(22) PCT Filed: Apr. 24, 2012
(86) PCT No.: PCT/EP2012/057480

§ 371 Date: Dec. 5, 2013

(30) Foreign Application Priority Data
May 26, 2011 (FR) 1154585

(51) Int. Cl. H04L 29/06

(52) U.S. Cl. CPC H04L 63/0428
USPC 713/168

(57) ABSTRACT

To control the publication of digital content on a web site managed by a publication server (SP) from a communication terminal (TC1), a control server (SC) capable of communicating with the publication server (SP) and the terminal provide the latter with an application (App) that is downloaded and implemented on the terminal. The application makes it possible to define the control parameters (ParC) associated with the digital content, said parameters comprising a period of validity for the content and a list of web sites authorised to publish the digital content, generate a key (Kc) associated with the digital content, encrypt the digital content with said key, and store the control parameters (ParC), the generated key (Kc), and the encrypted digital content in various databases. The application then generates a reference (Ref) associated with the digital content and requires the publication of the reference by the publication server in place of the digital content.

The present invention pertains to a digital content publication control system for a web site.

Currently, when a user wishes to publish content, such as an image or a video, on a web site, such as a social networking web site, the user has limited control over the fate of the published content. The user can authorise access to the published content only for a group of persons and can prohibit access for other persons.

In particular, the published content may be viewed and copied by another user visiting the web site and then republished on another web site, without said user knowing or having given his or her approval. Additionally, the web site upon which the content is published can store a copy of the latter, even if the user wishes to definitively delete the published content. Moreover, certain web sites use external applications making it possible to easily and automatically find published content, which adds an additional risk of uncontrolled redistribution of the published content.

Therefore, there is a need for users sharing content on web sites to maintain control over the usage of the content over the Internet, in particular the replication of the content on other web sites.

To remedy the aforementioned disadvantages, a method for controlling the publication of digital content on a web site managed by a publication server from a communication terminal, the communication terminal and publication server being capable of communicating with a control server that provides an application that is downloaded and implemented on the communication terminal, comprises the following steps within the communication terminal:

Defining the control parameters associated with the digital content, said parameters comprising a period of validity for the content and a list of web sites authorised to publish the digital content.

Generating a key associated with the digital content,

Encrypting the digital content with the generated key,

Storing the control parameters and the generated key in a first database and the encrypted digital content in a second database,

Generating a reference associated with the digital content, and

Requesting the publication server to publish the reference in place of the digital content.

Advantageously, the publication server must request authorisation from the control server for the content to be provided. The content owner can maintain control over the sites publishing content as well as the lifespan of the published content. Additionally, the encrypted content is decrypted at the location of the encryption key each time the content is displayed. Since the web site only publishes a reference to the content, the user is protected from any malfunction or security breach at the web site that may lead to undesired distribution of the content.

According to another characteristic of the invention, the steps of defining the control parameters, generating a key, encrypting the digital content, storing the control parameters, the generated key and the encrypted digital content, and generating a reference, may be carried out by the application communicating with the control server and under the control of the latter through an interface provided by the application.

According to another characteristic of the invention, the publication server can publish the reference after having been authenticated by the control server.

According to another characteristic of the invention, the application can also generate an identifier containing the addresses where the key and control parameters are stored, the identifier being included in the reference or stored together with the reference on the control server. For example, the reference is a URL at which the encrypted content is stored.

According to another characteristic of the invention, the method also comprises the following steps within the control server, when a user wishes to access the digital content associated with the reference published by the publication server through another terminal communication:

Retrieving the control parameters, key, and encrypted content from the addresses indicated by the identifier associated with the reference,

Verifying that the digital content associated with the reference can be accessed after analysing the control parameters,

Decrypting the encrypted digital content with the encryption key, and

Transmitting the decrypted content to the second communication terminal.

The encrypted content is decrypted externally to the publication server, thus preventing access to the encryption key and decrypted content through the publication server.

According to another characteristic of the invention, the control server may compare two IP addresses from said other communication terminal received respectively from the latter and from the publication server in order to verify that the request to access the digital content by said other communication terminal was in fact from the web site managed by the publication server.

The invention also pertains to a control server to control the publication of digital content on a web site managed by a publication server from a communication terminal, the communication terminal and publication server being capable of communicating with the control server, which provides an application that is downloaded and implemented on the communication terminal, the control server comprising:

The means to define the control parameters associated with the digital content, said parameters comprising a period of validity for the content and a list of web sites authorised to publish the digital content,

The means to generate a key associated with the digital content

The means to encrypt the digital content with the generated key,

The means to store the control parameters and the generated key in a first database and the encrypted digital content in a second database,

The means to generate a reference associated with the digital content, so that the publication server publishes the reference in place of the digital content.

According to another characteristic of the invention, the control server is capable of communicating with the publication server when a user wishes to access the digital content associated with the reference published by the publication server through another terminal communication, and also comprises:

The means to retrieve the control parameters, key, and encrypted content from the addresses indicated by the identifier associated with the reference,

The means to verify that the digital content associated with the reference can be accessed after analysing the control parameters,

The means to decrypt the encrypted digital content with the encryption key, and

The means to transmit the decrypted content to the second communication terminal.

The invention also pertains to a communication terminal to control the publication of digital content on a web site managed by a publication server from the communication terminal, the communication terminal and publication server being capable of communicating with the control server, which provides an application that is downloaded and implemented on the communication terminal, the communication terminal comprising:

The means to define the control parameters associated with the digital content, said parameters comprising a period of validity for the content and a list of web sites authorised to publish the digital content,

The means to generate a key associated with the digital content

The means to encrypt the digital content with the generated key,

The means to store the control parameters and the generated key in a first database and the encrypted digital content in a second database,

The means to generate a reference associated with the digital content,

The means to require the publication server to publish the reference in place of the digital content.

The invention also pertains to computer programs capable of being implemented within a server and a terminal, said programs comprising instructions that, whenever the program is executed within said server and said terminal, carry out the steps according to the inventive method.

The present invention and the benefits thereof shall be better understood upon examining the description below, which makes reference to the attached figures, in which:

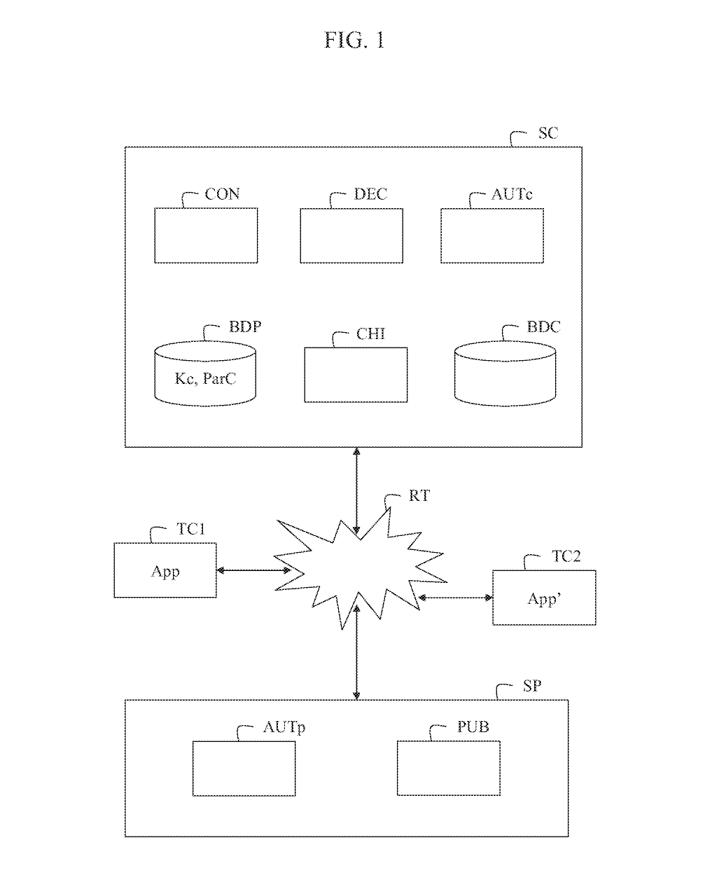

FIG. 1 is a schematic block diagram of a communication system according to one embodiment of the invention, and

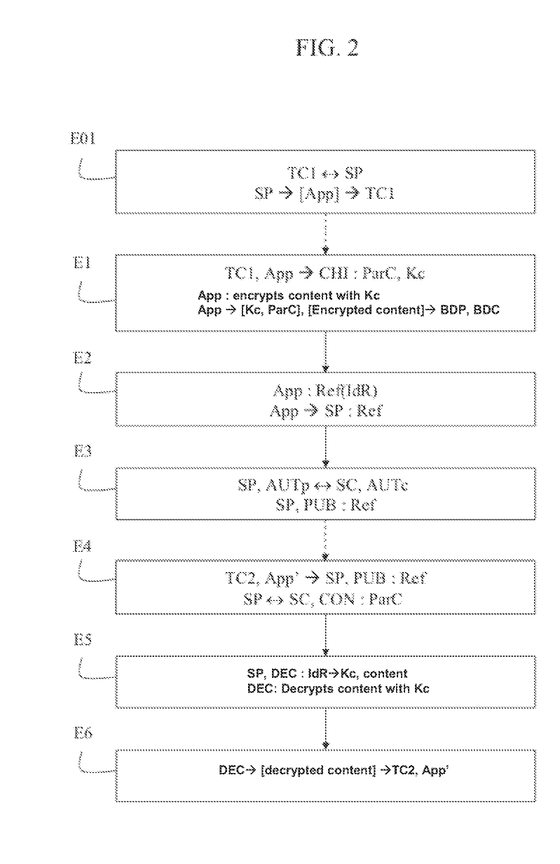

FIG. 2 is an algorithm of a method for controlling the publication of content in a web site according to one embodiment of the invention.

With reference to FIG. 1, a communication system comprises a control server SC, at least one publication server SP, a first communication terminal TC1, and a second communication terminal TC2, capable of communicating with one another over a telecommunication network RT.

The telecommunication network RT may be a wired or wireless network, or a combination of wired and wireless networks.

In one example, the telecommunication network RT is a high-speed IP (“Internet Protocol”) packet network, such as the Internet or an intranet.

In another example, the telecommunication network RT is a TDM (“Time Division Multiplexing”) network or a private network specific to a company supporting a proprietary protocol.

In the remainder of the description, it will be considered that the first communication terminal TC1 belongs to a first user who wishes to have digital content published through the publication server PUB, the digital content being stored on the control server SC and accessible through the publication server PUB to be displayed on the second communication terminal TC2 belonging to a second user who wishes to view the published digital content.

A communication terminal TC1 or TC2 of a user is connected to the control server SC and the publication server SP over the telecommunication network RT.

In one example, a communication terminal is a personal computer directly linked by modem to an xDSL (“Digital Subscriber Line”) or ISDN (“Integrated Services Digital Network”) link connected to the telecommunication network RT.

In another example, a communication terminal is a mobile cellular radiocommunication terminal, linked to the telecommunication network by a radiocommunication channel, for example of the GSM (“Global System for Mobile communications”) or UMTS (“Universal Mobile Telecommunications System”) type.

In another example, a communication terminal comprises an electronic telecommunication device or object that may be a personal digital assistant (PDA) or a smartphone, capable of being connected to an antenna on a public wireless local area network WLAN, a network using the 802.1x standard, or a wide area network using the WIMAX (“World wide Interoperability Microwave Access”) protocol, connected to the telecommunication network.

In another example, the communication terminal is a TDM landline telephone or a Voice-Over-IP landline telephone. In another example, the communication terminal is a POE (“Power Over Ethernet”) landline telephone that is powered via an Ethernet connection.

The first communication terminal TC1 contains an application App enabling terminal TC1 to communicate both with the publication server PUB and the control server SC. For example the application App is contained in a web browser.

The publication server SP is a server hosting a web site such as a social networking site, enabling users to publish digital content. Digital content may be, as examples, a multimedia object containing video and/or audio data, a text document, or an image.

The publication server SP contains a publication module PUB and an authentication module AUTp.

In the remainder of the description, the term module may designate a device, a software program, or a combination of computer hardware and software, configured to execute at least one particular task.

The publication module PUB communicates with the first communication terminal TC1 for the request to publish digital content by a first user and communicates with the second communication terminal TC2 for the request to display the published content by a second user.

The authentication module AUTp collaborates with the control server SC for authentication by the latter and authorisation to manage a digital content publication request.

The control server SC is a server that operates independently of the publication server SP and that collaborates with the publication server PUB to publish digital content by the publication server PUB under the control of the control server SC.

The control server SC comprises an encryption module CHI, a decryption module DEC, an authentication module AUTp, and a control module CON.

The encryption module CHI initially collaborates with the first communication terminal TC1 to enable the first user to create an account on the control server SC and to configure general access control rules. In particular, said rules define a list of web sites authorised to publish the content, each web site capable of being associated with a given period of validity for publishing content, which is to say the given content may be accessible through the given web site only during the period of validity. Said rules may also define notification modes for the first user, for example by text message or by email when content is blocked. In one embodiment, the encryption module CHI provides the application App that is downloaded to the first communication terminal TC1.

The encryption module CHI then collaborates with the first communication terminal TC1 to enable the first user to request publication of digital content on the web site from the publication server PUB.

More specifically, when the first terminal TC1 is connected to the web site of the publication server PUB, and the user wishes to publish content, the application App communicates with the control server SC so that the latter can manage publication of the content.

The encryption module CHI asks the first user to define control parameters ParC associated with the content, such as a period of validity for the content and a list of web sites authorised to publish the content.

The encryption module CHI generates a key Kc associated with the content and encrypts the content with the generated key. The encryption module CHI stores the generated key Kc in a database of parameters BDP and stores the encrypted content in a content database BDC. The databases BDP and BDC are integrated into the control server SC or, in one variant, are each incorporated into a database management server connected to the control server SC by a secure local or remote link.

The encryption module CHI also generates a reference Ref associated with the digital content. The reference Ref is, for example, a URL (“Uniform Resource Locator”). Optionally, if the content is a given image, the reference may comprise a miniature image of the given image.

The encryption module CHI stores the reference Ref together with an identifier IdR enabling the retrieval of the key Kc, the parameters ParC, and the encrypted content from the databases BDP and BDC. For example, the identifier IdR contains the addresses where the key Kc, the Parameters ParC, and potentially the encrypted content are stored.

The encryption module CHI transmits the reference Ref to the application App, which requires the publication server PUB to publish the reference Ref.

In another embodiment, the application App communicates with the control server SC to download and install a module comprising the functionalities of the encryption module CHI. The application then carries out the actions described above on its own, which is to say asking the first user to define the control parameters ParC, generating a key Kc associated with the content, encrypting the content with the generated key, and generating a reference Ref associated with the digital content. In this embodiment, the application App requires that the publication server SP publish the reference Ref, the reference Ref includes an identifier IdR as a parameter enabling retrieval of the key Kc, the parameters ParC, and the encrypted content from the databases BDP and BDC.

The authentication module AUTc has the functionality of authenticating the publication server PUB by collaborating with the authentication module AUTp on the latter. In particular, the control server SC and the publication server PUB each store authentication certificates in a database.

After authentication of the publication server SP by the control server SC, the publication server SP may publish the reference Ref through the publication module PUB.

If the first user wishes to publish content on a web site not contained on the initially defined list of authorised web sites, the authentication module AUTc on the control server SC shares certificates with the authentication module AUTp on the publication server SP.

Once the publication server SP has published the reference on a web site, the reference may be accessed by a second communication terminal TC2 requesting to display the content associated with the reference.

The second communication terminal TC2 contains an application App′ enabling terminal TC2 to communicate both with the publication server PUB and the control server SC. For example the application App′ is contained in a web browser.

The publication module PUB on the publication server SP communicates with the control module CON of the control server SC in order to verify the control parameters ParC associated with the reference Ref. To that end, the control module CON uses the identifier IdR stored together with the reference Ref by the encryption module CHI or uses the identifier IdR configured in the reference Ref.

Optionally, the control module CON receives an IP address, potentially hashed, from the second communication terminal TC2, transmitted by the publication server PUB and also receives an IP address, potentially hashed in the same way, from the second communication terminal TC2, transmitted by the application App′. The control module CON compares the IP addresses received in order to verify that the publication server SP is in fact authorised to publish the reference by using certificate authentication, and that the request to access the content by the second terminal was in fact made from the web site on the publication server SP.

Once the control module CON has verified the control parameters ParC, that is to say, it has verified that the first user authorised publication of the content through the reference, the control module CON triggers the decryption of the encrypted content by the decryption module DEC.

The decryption module DEC uses the identifier IdR associated with the reference Ref to retrieve the encryption key Kc stored in the database BDP and the encrypted content in the database BDC. The decryption module DEC decrypts the encrypted content with the encryption key Kc and transmits the decrypted content to the application App′ that can display the content. It is considered that the application App′ is equipped with mechanisms to prevent copying such as by a screen-capture.

In one embodiment, the application App′ communicates with the control server SC to download and install a module comprising the functionalities of the decryption module DEC.

In one embodiment, the decryption module DEC is incorporated into a server separate from the control server SC.

With reference to FIG. 2, a method for controlling publication of content on a web site according to one embodiment of the invention comprises steps E1 to E6 executed within the communication system.

In a preliminary step E01, the first user connects to the control server SC through the first communication terminal TC1. The first user creates an account on the control server SC and configures general access control rules defining in particular a list of web sites authorised to publish content and a given period of validity for publishing content for each web site.

Additionally the control server SC provides an application App that is downloaded and implemented within the first communication terminal TC1.

In step E1, the first user connects to the publication server SP through the first communication terminal TC1, with the goal of publishing content on the web site on the publication server SP.

If the application App does not have the functionalities of the encryption module CHI for encryption and generation of a reference, the application App may communicate with the control server SC to download and install these functionalities.

It is considered that steps E1 to E3 are executed by the application App, communicating with the encryption module CHI and under the control of the latter through an interface provided by the application App if the application App does not have the functionalities of the encryption module CHI.

The application App asks the first user to define control parameters ParC associated with the content, such as a period of validity for the content and a list of web sites authorised to publish the content. The application App generates a key Kc associated with the content and encrypts the content with the generated key.

The application App stores the control parameters ParC and the generated key Kc in a database of parameters BDP and stores the encrypted content in a content database BDC.

In step E2, the application App generates a reference Ref associated with the digital content. The reference Ref is, for example, an address, such as a URL, at which the encrypted content is stored. The application App also generates an identifier IdR containing the addresses where the key Kc and parameters ParC are stored. The identifier IdR is included in the reference Ref, for example, configured as a parameter of the reference Ref.

The application App requires that the publication server SP publish the reference Ref in place of the content.

In step E3, the AUTp module on the publication server SP communicates with the AUTc module on the control server SC in order to be authenticated by the latter. Once authenticated, the publication server SP then publishes the reference Ref in place of the content, using the publication module PUB.

In step E4, a second user connects to the publication server SP through a second communication terminal TC2, with the goal of displaying the published content.

The second communication terminal TC2 has an application App′ capable of communicating with the publication server SP and the control server SC, the application App′ being for example included in or a plug-in within a web browser.

When the web browser opens a web page upon which the reference Ref is published, the application App′ submits an HTTP (“HyperText Transfer Protocol”) request to the publication server SP. The publication module PUB on the publication server SP then communicates with the control module CON on the control server SP in order to verify the control parameters ParC associated with the reference Ref, which is to say to verify whether or not the content associated with the reference can be accessed after analysing the control parameters ParC, by using the identifier IdR associated with the reference Ref to retrieve the control parameters ParC.

Optionally, the control module CON compares two IP addresses from the second communication terminal TC2 received respectively from the publication server SP and the application App′.

In step E5, if the parameters ParC indicate that the content may be accessed, the decryption module DEC on the control server SC uses the identifier IdR associated with the reference Ref to retrieve the encryption key Kc and the encrypted content from the addresses indicated by the identifier IdR.

The decryption module DEC decrypts the encrypted content with the encryption key Kc.

In step E6, the decryption module DEC transmits the decrypted content, securely, to the application App′ that can display the decrypted content.

The method according to steps E4 to E6 is transparent for the second user who sees the content associated with the web site visited displayed on his or her screen, the content having been downloaded from the control server SC instead of the publication server SP.

The invention described here relates to a method, a terminal, and a server for controlling the publication of digital content. According to one embodiment of the invention, the steps in the inventive method are determined by the instructions of computer programs incorporated into a server, such as the control server SC, and incorporated into a terminal, such as the communication terminal TC1. The programs comprise program instructions that, when said programs are loaded and executed within the server and the terminal, carry out the steps of the inventive method.

Consequently, the invention also applies to a computer program, particularly a computer program on or within an information medium, suitable to implement the invention. This program may use any programming language, and be in the form of source code, object code, or intermediate code between source code and object code, such as in a partially compiled form, or in any other form desirable for implementing the inventive method.

1-12. (canceled)

13. A method for controlling the publication of digital content, the method comprising the steps of:
defining a plurality of control parameters associated with a digital content;
generating a key associated with the digital content,
encrypting the digital content using the key to generated encrypted digital content,
storing the plurality of control parameters and the key in a first database and the encrypted digital content in a second database;
generating a reference associated with the digital content; and
communicating the reference to a server for publication.

14. The method of claim 13, wherein the step of defining the plurality of control parameters comprises defining a period of validity parameter.

15. The method of claim 13, wherein the step of defining the plurality of control parameters comprises defining a list comprising of at least one authorized publishing website parameter.

16. The method of claim 13, wherein the step of generating a reference comprises generating an identifier containing a key address indicating where the key is stored and a control parameters address indicating where the plurality of control parameters are stored, the identifier being included in the reference.

17. The method of claim 13, wherein the reference is a URL indicating where the encrypted digital content is stored.

18. The method of claim 13, further comprising the steps of:
receiving information from the server;
retrieving the plurality of control parameters and the key using the information;
verifying that the digital content associated with the plurality of control parameters can be accessed after analysing the plurality of control parameters;
decrypting the encrypted digital content using the key to generate decrypted digital content; and
communicating the decrypted digital content for display.

19. The method of claim 18, wherein the step of communicating comprises communicating with a user terminal.

20. The method of claim 19, further comprising the step of comparing a first IP address from the user terminal and a second IP address received from the first server in order to verify that the request to access the digital content by the user terminal was from a web site managed by the server.

21. A method for controlling the publication of digital content, the method comprising the steps of:
receiving information from a server;
retrieving a plurality of control parameters and a key using the information;
verifying that a digital content associated with the plurality of control parameters can be accessed after analysing the plurality of control parameters;
decrypting an encrypted digital content using the key to generate decrypted digital content; and
communicating the decrypted digital content for display.

22. The method of claim 21, wherein the step of communicating comprises communicating with a user terminal.

23. The method of claim 22, further comprising the step of comparing a first IP address from the user terminal and a second IP address received from the first server in order to verify that the request to access the digital content by the user terminal was from a web site managed by the server.

24. A computer program capable of being implemented within a communication device to control the publication of digital content, the program comprising instructions that, when the program is loaded and executed within the communication device, carries out the steps comprising of:
defining a plurality of control parameters associated with a digital content;
generating a key associated with the digital content,
encrypting the digital content using the key to generated encrypted digital content,
storing the plurality of control parameters and the key in a first database and the encrypted digital content in a second database;
generating a reference associated with the digital content; and
communicating the reference to a first server for publication.

25. The computer program of claim 24, being implemented in a user device.

26. The computer program of claim 24, further carrying out the steps comprising of:
receiving information from the first server;
retrieving the plurality of control parameters and the key using the information;
verifying that the digital content associated with the plurality of control parameters can be accessed after analysing the plurality of control parameters;
decrypting the encrypted digital content using the key to generate decrypted digital content; and
communicating the decrypted digital content for display.

27. The computer program of claim 26, being implemented in a second server.

28. The computer program of claim 26, wherein the step of communicating comprises communicating with a user terminal.
